(19) United States
(12) Patent Application Publication
(10) Pub. No.: US 2003/0005095 A1
(43) Pub. Date: Jan. 2, 2003

(54) Method and system for programmable submarine network configuration plans to enable diverse service level agreements in telecommunication networks

(76) Inventor: John A. Fee, Garland, TX (US)

Correspondence Address: WORLDCOM, INC., TECHNOLOGY LAW DEPARTMENT, 1133 19TH STREET NW, WASHINGTON, DC, 20036, US

(21) Appl. No.: 09/896,382

(22) Filed: Jun. 29, 2001

(51) Int. Cl. G06F 15/177

(52) U.S. Cl. 709/221; 709/224

(57) ABSTRACT

An approach for providing network management of a submarine cable network. A line terminating equipment monitors a plurality of physical connections of the submarine cable network. A network management module receives selectively an alarm signal from the line terminating equipment or network management system and reconfigures the submarine cable network based upon the received alarm signal. According to one embodiment of the present invention, the submarine cable network is a dense wave division multiplexing (DWDM) system.

### BACKGROUND OF THE INVENTION

1. Field of the Invention

The present invention relates to a communication system, and is more particularly related to a network restoration architecture for supporting telecommunication services and networks.

2. Discussion of the Background

Submarine cable networks continue to provide a viable solution for joining geographically dispersed sites. FIG. 4 shows a typical submarine cable network, which connects continents A and B together over three separate cables that terminate at three separate sets of nodes. Traditionally, the cables 401, 403, and 405 are operated by different service providers, largely in part because of the cost of cable deployment. In a typical submarine cable network build, capacity is usually shared among these different service providers, who own the cable, to meet the requirements of their subscribers (i.e., customers).

Therefore, conventional submarine cable builds do not offer much network protection, as these different service providers do not possess a viable mechanism to manage the collective network. It is noted that although the terrestrial portion of a service provider's network may provide availability as high as 99.999%, the vulnerability of deep water cable cuts and associated long MTTR (Mean Time To Repair), the overall availability may be greatly reduced. With the forecasted growth in IP (Internet Protocol) traffic for example, exponential growth in international traffic is expected. The availability requirements for premium services are ever increasing and demanding.

In light of the network management constraints of the service providers associated with cables 401, 403, and 405, these service providers have little flexibility in offering a diverse range of service level agreements (SLA). For instance, if the service provider of cable 401 experiences a peak traffic level that exceeds the capacity of cable 401, this service provider may or may not divert overflow traffic to the other two service providers, depending on the traffic load of these other service providers. In addition, the susceptibility to a single point of failure may preclude the service provider of cable 401 from providing many different types of SLAs.

Based on the foregoing, there is a clear need for improved approaches for providing network restoration and provisioning services in submarine systems.

There is also a need to enhance network availability in systems that utilize submarine cables.

There is a further need to increase network management functionalities in submarine systems to provide a variety of service level agreements.

Based on the need to enhance the network availability, an approach for implementing a network protection mechanism in a submarine cable network is highly desirable.

### SUMMARY OF THE INVENTION

The present invention addresses the above stated needs by providing a capability to restore and provision services over a submarine network. The submarine network, which may exhibit a number of different network topologies, utilizes nodes that terminate each end of the submarine cables. The nodes include terminating equipment that monitors the submarine cables for alarms. The alarms are stripped by binary interfaces within the terminating equipment and forwarded to a network management module or system, which in turn instructs a switch to retrieve an appropriate restoration or provisioning plan. The restoration is automatically performed through a series of pre-programmed instructions; the restoration may be executed on a per-fiber strand basis or per-fiber cable basis. Additionally, the network management module manages the capacity of the submarine network to provide provisioning services.

According to one aspect of the invention, a method is provided for providing network management of a submarine cable network. The method includes monitoring a plurality of physical connections between a first line terminating equipment and a second line terminating equipment. The method also includes selectively receiving alarm signals from at least one of the first line terminating equipment and the second line terminating equipment. Further, the method includes reconfiguring the submarine cable network based upon the receiving step. Under this approach, availability of submarine networks is enhanced.

According to another aspect of the invention, a communication system for providing network management of a submarine cable network comprises a line terminating equipment that is configured to monitor a plurality of physical connections of the submarine cable network. A network management module is configured to receive selectively an alarm signal from the line terminating equipment and to reconfigure the submarine cable network based upon the received alarm signal. The above arrangement advantageously provides efficient restoration of services in the event of network faults associated with the physical connections of a submarine network.

In another aspect of the invention, a computer-readable medium carrying one or more sequences of one or more instructions for providing network management of a submarine cable network is provided. The one or more sequences of one or more instructions include instructions which, when executed by one or more processors, cause the one or more processors to perform the step of monitoring a plurality of physical connections between a first line terminating equipment and a second line terminating equipment. Another step includes selectively receiving alarm signals from at least one of the first line terminating equipment and the second line terminating equipment. Yet another step includes reconfiguring the submarine cable network based upon the receiving step. This approach advantageously enhances efficiency of provisioning services in a network that utilize submarine cables.

In yet another aspect of the invention, a communication system for providing network management of a submarine cable network comprises means for monitoring a plurality of physical connections of the submarine cable network. The system also includes means for selectively receiving alarm signals from the monitoring means, and means for reconfiguring the submarine cable network based upon the received alarm signals. Under this approach, service level agreements can be ensured.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1A and 1B are diagrams of a programmable submarine network that is capable of performing network reconfiguration under normal and restorative operating conditions, respectively, in accordance with an embodiment of the present invention;

FIGS. 2A and 2B are flowcharts of the reconfiguration process of the system of FIG. 1 for network restoration and service provisioning, respectively;

FIG. 3 is a diagram of a computer system that can perform the reconfiguration processes of FIGS. 2A and 2B; and

FIG. 4 is a diagram of a conventional submarine network employing an optical link between two continents.

### DESCRIPTION OF THE PREFERRED EMBODIMENTS

In the following description, for the purpose of explanation, specific details are set forth in order to provide a thorough understanding of the invention. However, it will be apparent that the invention may be practiced without these specific details. In some instances, well-known structures and devices are depicted in block diagram form in order to avoid unnecessarily obscuring the present invention.

The present invention accomplishes reconfiguration of a submarine network to restore services in the event of network faults and to perform service provisioning. A telecommunications node includes a line terminating equipment that monitors physical connections of the submarine cable network. The system utilizes binary interfaces as well as network management interfaces to detect the network faults; whereby, if the fault goes undetected by the binary interfaces, then the network management interfaces provide another mechanism to trigger network restoration. Although the present invention is discussed with respect to optical networking, it is recognized by one of ordinary skill in the relevant art that the present invention has applicability to communications networks in general.

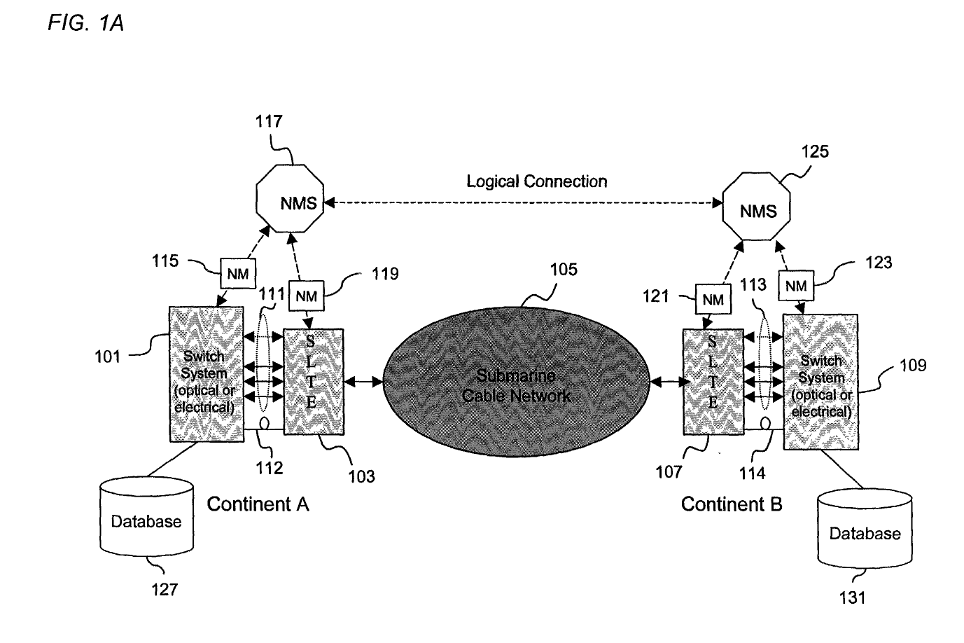

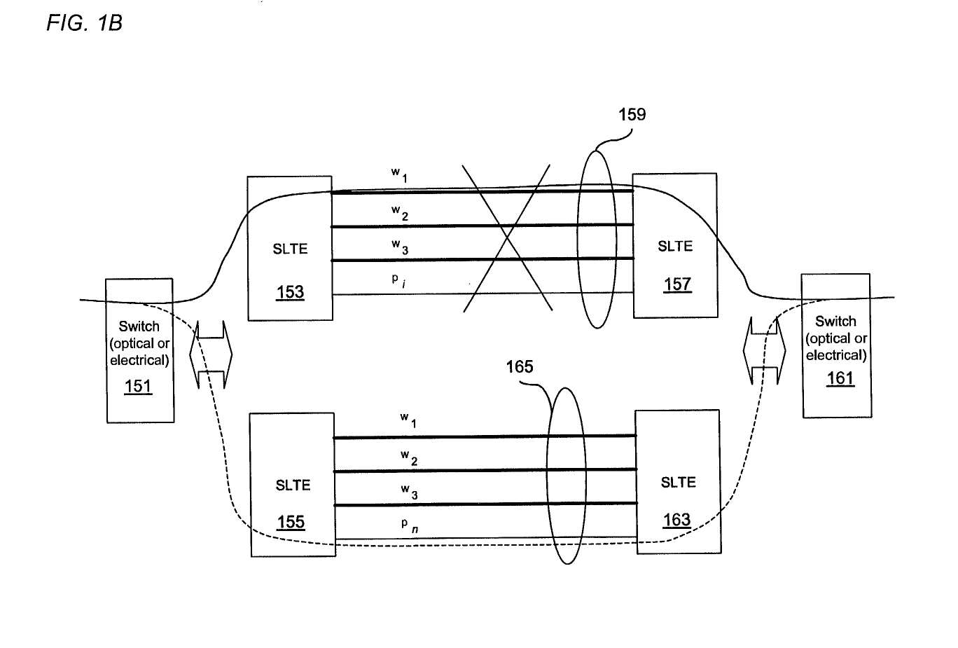

FIG. 1A shows a submarine cable network that is capable of performing network reconfiguration, in accordance with an embodiment of the present invention. It is recognized that the cost of deployment of intercontinental cabling has diminished in cost; accordingly, carriers may build new cables to provide shared protection links for working capacity of existing cables. As shown in the FIG. 1A, a switching system 101 resident in Continent A, for example, is used to connect a submarine Line Terminating Equipment (SLTE) 103 or banks of SLTEs with dedicated cables in submarine cable network 105 to offer provisioning, protection, and restoration. The submarine cable network 105 may exhibit any number of topologies; according to one embodiment of the present invention, the submarine cable network 105 is a meshed network that connects a number of telecommunication nodes (in which, for explanatory purposes, only a single node is shown at each end of the submarine cable network 105). Additionally, in an exemplary embodiment, the switching system 101 provides an electrical switch fabric that switches at STS (Synchronous Transport Signal) (STM [Synchronous Transport Module])-N(M) (N>=48, M>=16).

Alternatively, another embodiment of the present invention supplies an all-optical switch fabric that is transparent to bit rate, protocol, and format of the optical signals on the wavelengths of a DWDM (dense wave division multiplexing) fiber. In such an implementation, SLTEs 103 and 107 utilize DWDM equipment, such as a dense wavelength division multiplexer for multiplexing many light wave carriers having different frequencies over the submarine cable network 105. Across the expansive distance of submarine cable network 105, signal amplifying equipment, such as optical amplifiers (not shown) and/or an optical regenerators (not shown) are employed to maintain proper signal strength. SLTEs 103 and 105 contain optical transmitters and receivers (not shown) to transport optical signals over the submarine cable network 105. The optical signals may be transported over separate fibers within a single physical optical cable and/or over diverse optical cables.

Submarine cable network 105 connects SLTE 103 to another SLTE 107 (or bank of SLTEs) within Continent B. SLTE 107 couples to switching system 109. At each landing station (node) of the submarine cable network 105, a binary interface (e.g., 111 and 113) between the switching system (e.g., 101 and 109) and SLTE (e.g., 103 and 107) communicates alarm information associated with a network fault. Additionally, a SONET (Synchronous Optical Network) STM-N interface (e.g., 112 and 114) transports STM-N signals to provide alarm information.

As used herein, the term “binary interface” generally refers to a means for communicating alarms and status conditions (such as equipment malfunctions, signal degradations, etc.) directly from one network element to another, as opposed to embedding such information in the overhead of a traffic-bearing signal, such as along SONET STM-N interface 112. A binary interface may provide more immediate and dependable communication of alarm and status information, especially if other robustness measures, such as error-tolerant coding schemes, are applied to the binary interface 111, 113. The binary interface 111, 113 yields a faster response time than the usual embedded interface (in the order of microseconds versus milliseconds, for example). The binary interface 111, 113 sends to the switching system controller; in turn, the switching system controller analyzes the fault and refers to the lookup tables in the database 127, 131 rather than the embedded signal analyzing the fault and sending the message (delayed by the analysis time) to the switching system controller. Since the switching system 101, 109 must perform the root cause analysis anyway (fault conditions), the embedded analysis is a redundant event.

Given the advantages of the binary interface 111, 113, the protect switching or restoration mechanisms of the system 101, according to one embodiment of the present invention, rely primarily upon direct indications from the binary interface 111, 113, although such systems may also respond to signal overhead bytes and communications through a network management system.

According to one embodiment of the present invention, a network management module receives alarm signals from the line terminating equipment and reconfigures the submarine cable network based upon the received alarm signal. At the node within continent A, switching system contains network management interfaces 115 and 117 to a network management system 101 (NMS) 117. Similarly, the node in continent B utilizes network management interfaces 121, 123. In an exemplary embodiment, alarm information is extracted based upon the following priority of sources: the binary interfaces 111 and 113; the STM-N interfaces 112 and 114; and NM interfaces 115, 119, 121, and 123. The above priority is based upon the speed, in relative terms, by which the alarm information can be obtain, with the binary interfaces 111 and 113 being the fastest and the NM interfaces 115, 119, 121, and 123 being the slowest. For instance, if the binary interface 111, 113 or the STM-N interface 112, 114 fail to detect the fault based on pre-determined failure states, then network management (NM) interfaces (e.g., 115, 119, 121, and 123) are relied upon to trigger any necessary restoration procedures.

It should be noted that although NMS 117 is shown as a separate system, in an alternative embodiment, the NMS 117 may be a network management module associated with switching system 101. SLTE 103 also communicates with NMS 117 via a separate NM interface 119. A similar configuration is used for the node in Continent B; SLTE 107 and switching system 109 possess NM interfaces 121 and 123 to a NMS 125.

NMSs 117 and 125 form a logical connection (i.e., controller) network for global management over the submarine cable network 105 to coordinate the reconfiguration of the submarine cable network 105. The switching systems 101 and 109 use alarm information from the respective SLTEs 103 and 107 to trigger a restoration event based on, for example, lookup state tables with pre-programmed restoration plans. These state tables, in an exemplary embodiment, are stored within databases 127 and 131 that are coupled to switching systems 101 and 109, respectively. Databases 127 and 131 store look-up tables that trigger pre-determined activities according to the alarms. According to one embodiment of the present invention, the look-up tables specify restoration plans; in addition to or alternatively, the look-up tables trigger activities related to provisioning of services related to the submarine cable network 105.

The restoration plans that are selected can be optimized based on classes of service of the different signals that were affected. Specifically, these restoration plans can be programmed based on Service Level Agreements (SLAs) as executed between service providers and their customers. For example, the SLA parameters are pre-computed and are prioritized accordingly, such that upon occurrence of a failure, those links corresponding to the higher priority SLAs are restored before the lower priority SLAs. Programmed restoration plans may include 1+1, 1:1, 1:N (N>=2), N:N, N:M, ring, mesh with different restoration times on a combination of submarine, terrestrial and/or festoon geographical networks. An exemplary mesh optical network is further detailed in U.S. Pat. No. 6,038,044 (Fee et al.), entitled “Ring/Mesh Optical Network”, which is incorporated herein in its entirety.

The NMSs 117 and 125 may also provide provision of services by reconfiguring the submarine cable network 105 to accommodate additional capacity requirements of the customers. For example, a service provider associated with the submarine cable network 105 may sell capacity to various customers with a diverse set of requirements. These customer requirements may range from low priority traffic to mission critical data; therefore, the service provider may separately negotiate service level agreements with each of the customers. To effect these SLAs, provisioning data from an operation support system (not shown) of the submarine cable network 105 is supplied to the NMS 117. The provisioning data may include information that specifies the individual capacity requirements of the customers.

FIG. 1B shows a submarine cable network that provides network reconfiguration, according to an embodiment of the present invention, as a result of a cable cut. A switch 151, which may be optical or electrical, is coupled to SLTEs 153 and 155. SLTE 153 communicates with SLTE 157 via a cable 159, which supports multiple channels (i.e., routes). In this example, cable 159 provides a number of working channels (w₁, w₂, and, w₃) and a protection channel (pᵢ). SLTE 157 terminates at another switch 161, which may optical or electrical corresponding to switch 153. Switch 161 is also coupled to another SLTE 163 which connects to SLTE 155 over a cable 165—which provides working channels (w₁, w₂, and, w₃) and a protection channel (pₙ).

As seen in the example of FIG. 1B, a cable cut occurs on cable 159, disrupting communication between SLTE 153 and SLTE 157. At this point, the switch 151 is instructed to reroute the traffic that originally was carried by the w₁ route of cable 159 to the protection route pₙ of cable 165. As a consequence of this restoration procedure, the actual SLA for the duration of the restoration operation is different in that the protection route may be pre-empted if a service disruption occurs in the cable 159 that requires use of the protection route pₙ to support the traffic on the working channels w₁, w₂, and, w₃. Given the above configuration, the submarine cable network can provide rings, mesh, or other types of restoration and protection, using multiple diversely-routed cables (e.g., fibers).

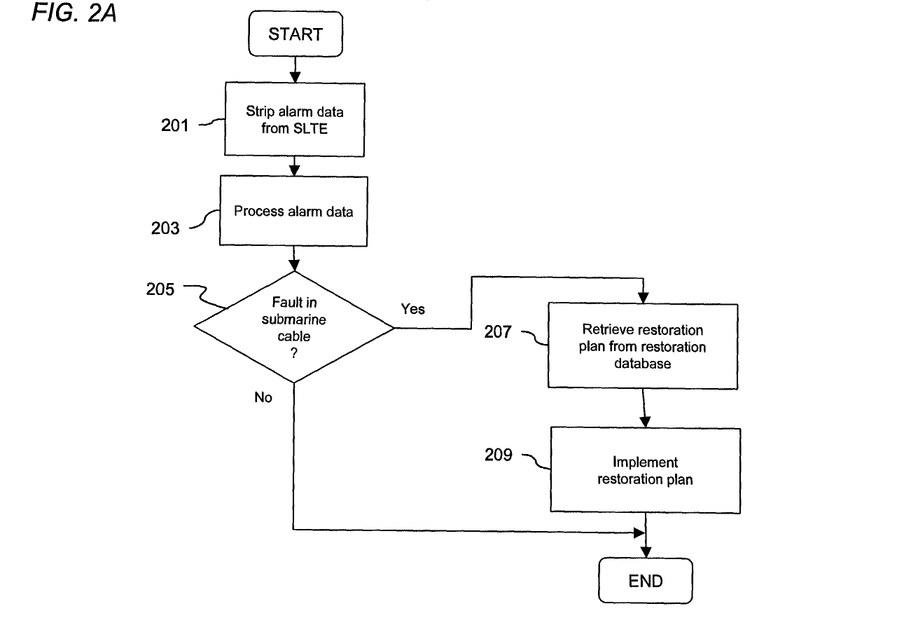

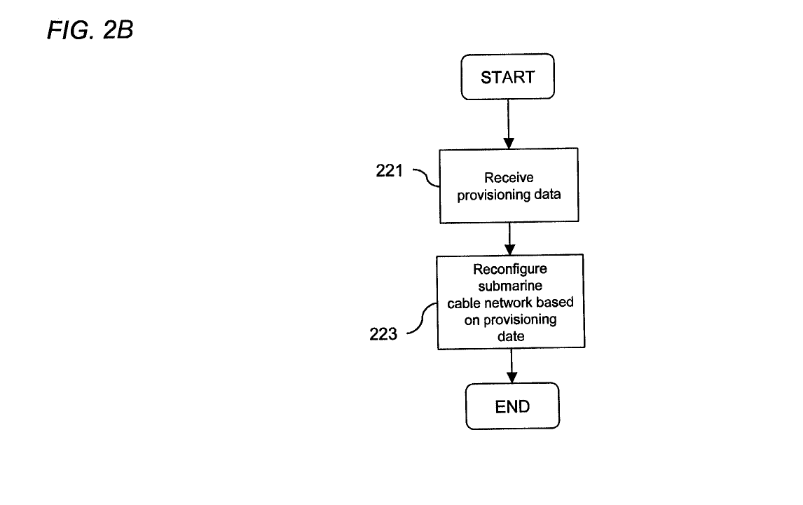

FIG. 2A is a flowchart of the reconfiguration process of the system of FIG. 1. For the purposes of explanation, it is assumed that submarine cable network 105 experiences a cable cut in one of its links. When this fault occurs, the SLTE 103 and SLTE 107 detect the cable cut; each of the SLTEs 103 and 107 generates alarm data and notifies the corresponding switching systems 101 and 109. The process of fault detection is more fully described in U.S. Pat. No. 5,914,794 (Fee et al.), entitled, “Method of and Apparatus for Detecting and Reporting Faults in an All-Optical Communications System,” which is incorporated herein in its entirety. The binary interfaces 111 and 113 strip the alarm data from the SLTEs 103 and 107, as in step 201. However, if the binary interfaces 111 and 113 (or the STM-N interfaces 112 and 114) are unable to strip the alarm data, then the switching system 101 forwards the alarm data through NM interface 115 to NMS 117; likewise, switching system 109 transmits the alarm data to NMS 125 via NM interface 123. In step 203, each of the NMSs 117 and 125 processes the received alarm data from the switching systems 101 and 109. The NMSs 117 and 125 coordinate the resolution of the detected fault over the logical connection network. If the detected fault is verified (per step 205), then the switching systems 101 and 109, as in step 207, retrieve the appropriate restoration plans from the restoration databases 127 and 131, respectively. Subsequently, the switching systems 101 and 109 implement the pre-programmed restoration plans, per step 209.

FIG. 2B shows a flowchart of the process of provisioning services on the submarine cable network. In step 221, the NMS 117 receives provisioning data from the operational support system, as mentioned above. Next, the received provisioning data, as in step 223, is processed by the NMS 117 to instruct the switching system 101. The switching system 101 updates switching tables appropriately to forward traffic over the submarine cable network 105.

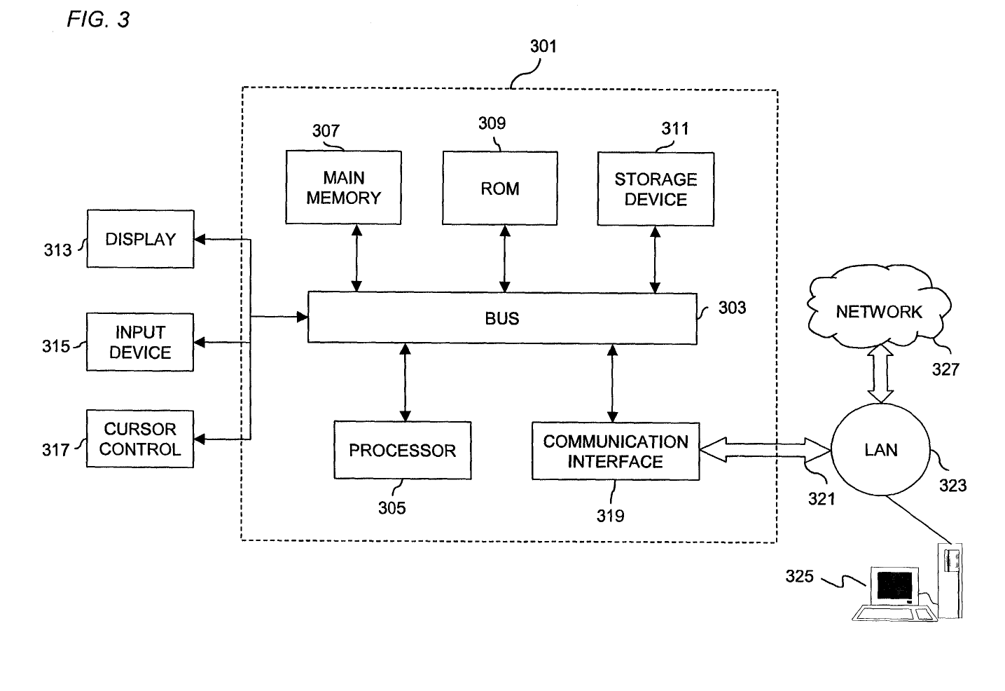

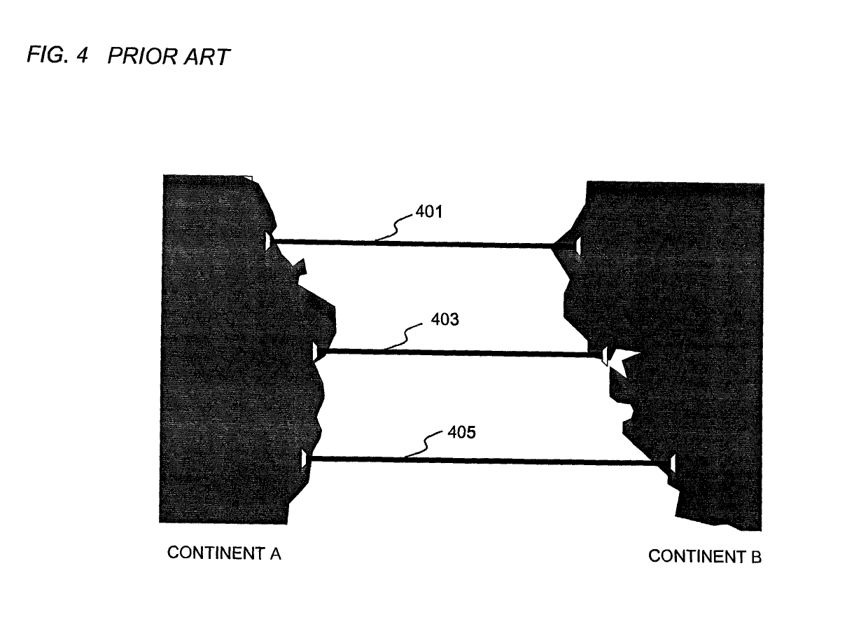

FIG. 3 shows a diagram of a computer system that can perform the reconfiguration processes of FIG. 2A and 2B. Computer system 301 includes a bus 303 or other communication mechanism for communicating information, and a processor 305 coupled with bus 303 for processing the information. Computer system 301 also includes a main memory 307, such as a random access memory (RAM) or other dynamic storage device, coupled to bus 303 for storing information and instructions to be executed by processor 305. In addition, main memory 307 may be used for storing temporary variables or other intermediate information during execution of instructions to be executed by processor 305. Computer system 301 further includes a read only memory (ROM) 309 or other static storage device coupled to bus 303 for storing static information and instructions for processor 305. A storage device 311, such as a magnetic disk or optical disk, is provided and coupled to bus 303 for storing information and instructions.

Computer system 301 may be coupled via bus 303 to a display 313, such as a cathode ray tube (CRT), for displaying information to a computer user. An input device 315, including alphanumeric and other keys, is coupled to bus 303 for communicating information and command selections to processor 305. Another type of user input device is cursor control 317, such as a mouse, a trackball, or cursor direction keys for communicating direction information and command selections to processor 305 and for controlling cursor movement on display 313.

According to one embodiment, the reconfiguration process is provided by computer system 301 in response to processor 305 executing one or more sequences of one or more instructions contained in main memory 307. Such instructions may be read into main memory 307 from another computer-readable medium, such as storage device 311. Execution of the sequences of instructions contained in main memory 307 causes processor 305 to perform the process steps described herein. One or more processors in a multi-processing arrangement may also be employed to execute the sequences of instructions contained in main memory 307. In alternative embodiments, hard-wired circuitry may be used in place of or in combination with software instructions. Thus, embodiments are not limited to any specific combination of hardware circuitry and software.

Further, the instructions relating to the restoration plans and provisioning may reside on a computer-readable medium. The term “computer-readable medium” as used herein refers to any medium that participates in providing instructions to processor 305 for execution. Such a medium may take many forms, including but not limited to, non-volatile media, volatile media, and transmission media. Non-volatile media includes, for example, optical or magnetic disks, such as storage device 311. Volatile media includes dynamic memory, such as main memory 307. Transmission media includes coaxial cables, copper wire and fiber optics, including the wires that comprise bus 303. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 305 for execution. For example, the instructions may initially be carried on a magnetic disk of a remote computer. The remote computer can load the instructions relating to network restoration remotely into its dynamic memory and send the instructions over a telephone line using a modem. A modem local to computer system 301 can receive the data on the telephone line and use an infrared transmitter to convert the data to an infrared signal. An infrared detector coupled to bus 303 can receive the data carried in the infrared signal and place the data on bus 303. Bus 303 carries the data to main memory 307, from which processor 305 retrieves and executes the instructions. The instructions received by main memory 307 may optionally be stored on storage device 311 either before or after execution by processor 305.

Computer system 301 also includes a communication interface 319 coupled to bus 303. Communication interface 319 provides a two-way data communication coupling to a network link 321 that is connected to a local network 323. For example, communication interface 319 may be a network interface card to attach to any packet switched local area network (LAN). As another example, communication interface 319 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 319 sends and receives electrical, electromagnetic and/or optical signals that carry digital data streams representing various types of information.

Network link 321 typically provides data communication through one or more networks to other data devices. For example, network link 321 may provide a connection through local network 323 to a host computer 325 or to data equipment operated by a service provider, which provides data communication services through an IP (Internet Protocol) network 327 (e.g., the Internet). LAN 323 and IP network 327 both use electrical, electromagnetic or optical signals that carry digital data streams. The signals through the various networks and the signals on network link 321 and through communication interface 319, which carry the digital data to and from computer system 301, are exemplary forms of carrier waves transporting the information. Computer system 301 can transmit notifications and receive data, including program code, through the network(s), network link 321 and communication interface 319.

The techniques described herein provide several advantages over prior approaches to management of a submarine cable network. A network management module is capable of receiving alarm signals from a line terminating equipment and reconfiguring the submarine cable network based upon the received alarm signal. The network management module may also initiate the reconfiguration of the submarine network to accommodate provisioning services. This arrangement advantageously permits a service provider to satisfy service level agreements with the customers.

Obviously, numerous modifications and variations of the present invention are possible in light of the above teachings. It is therefore to be understood that within the scope of the appended claims, the invention may be practiced otherwise than as specifically described herein.

What is claimed is:

1. A method for providing network management of a submarine cable network, the method comprising:
monitoring a plurality of physical connections between a first line terminating equipment and a second line terminating equipment;
selectively receiving alarm signals from at least one of the first line terminating equipment and the second line terminating equipment; and
reconfiguring the submarine cable network based upon the receiving step.

2. The method according to claim 1, wherein the reconfiguring step is performed to restore service according to a plurality of classes of services.

3. The method according to claim 1, wherein the reconfiguring step is performed to provision services on the submarine cable network.

4. The method according to claim 1, further comprising:
interfacing with the first line terminating equipment and the second line terminating equipment using binary alarm interfaces.

5. The method according to claim 1, wherein the steps of receiving the alarm signals and reconfiguring are performed by a network management module.

6. The method according to claim 5, wherein the network management module resides within at least one of the first line terminating equipment and the second line terminating equipment.

7. The method according to claim 5, wherein the network management module resides within a switching system.

8. The method according to claim 1, wherein the reconfiguring step is performed to provide restoration of the submarine cable network, the reconfiguring step comprising:
detecting a fault on one of the plurality of physical connections based upon the received alarm signals;
retrieving restoration information; and
rerouting the traffic on the one physical connections to another one of the plurality of physical connections based upon the restoration information.

9. The method according to claim 1, further comprising:
receiving provisioning data that include capacity requirements of a customer; and
reconfiguring the submarine cable network based upon the capacity requirements.

10. A communication system for providing network management of a submarine cable network, the system comprising:
a line terminating equipment configured to monitor a plurality of physical connections of the submarine cable network; and
a network management module configured to receive selectively an alarm signal from the line terminating equipment and to reconfigure the submarine cable network based upon the received alarm signal.

11. The system according to claim 10, further comprising:
a database configured to store restoration information, wherein the network management module reconfigures the submarine cable network to provide restoration services according to a plurality of classes of services and the stored restoration information.

12. The system according to claim 10, wherein the network management module reconfigures the submarine cable network to provision services on the submarine cable network.

13. The system according to claim 10, further comprising:
a switching system configured to forward and receive traffic from the submarine cable network; and
a binary interface coupled to the switching system and configured to strip alarm signals from the line terminating equipment, wherein the binary interface forwards the alarm signals to the network management module.

14. The system according to claim 13, wherein the network management module resides within the switching system.

15. The system according to claim 13, wherein the network management module resides within the line terminating equipment.

16. The system according to claim 10, wherein the network management module is further configured to detect a fault on one of the plurality of physical connections based upon the received alarm signals to reroute the traffic on the one physical connections to another one of the plurality of physical connections.

17. The system according to claim 10, wherein the network management module is further configured to receive provisioning data that include capacity requirements of a customer and to reconfigure the submarine cable network based upon the capacity requirements.

18. A computer-readable medium carrying one or more sequences of one or more instructions for providing network management of a submarine cable network, the one or more sequences of one or more instructions including instructions which, when executed by one or more processors, cause the one or more processors to perform the steps of:
monitoring a plurality of physical connections between a first line terminating equipment and a second line terminating equipment;
selectively receiving alarm signals from at least one of the first line terminating equipment and the second line terminating equipment; and
reconfiguring the submarine cable network based upon the receiving step.

19. The computer-readable medium according to claim 18, wherein the reconfiguring step is performed to restore service according to a plurality of classes of services.

20. The computer-readable medium according to claim 18, wherein the reconfiguring step is performed to provision services on the submarine cable network.

21. The computer-readable medium according to claim 18, wherein the one or more processors further perform the step of:
interfacing with the first line terminating equipment and the second line terminating equipment using binary alarm interfaces.

22. The computer-readable medium according to claim 18, wherein the steps of receiving the alarm signals and reconfiguring are performed by a network management module.

23. The computer-readable medium according to claim 22, wherein the network management module resides within at least one of the first line terminating equipment and the second line terminating equipment.

24. The computer-readable medium according to claim 22, wherein the network management module resides within a switching system.

25. The computer-readable medium according to claim 18, wherein the reconfiguring step is performed to provide restoration of the submarine cable network, the reconfiguring step comprising:
detecting a fault on one of the plurality of physical connections based upon the received alarm signals;
retrieving restoration information; and
rerouting the traffic on the one physical connections to another one of the plurality of physical connections based upon the restoration information.

26. The computer-readable medium according to claim 18, wherein the one or more processors further perform the step of:
receiving provisioning data that include capacity requirements of a customer; and
reconfiguring the submarine cable network based upon the capacity requirements.

27. A communication system for providing network management of a submarine cable network, the system comprising:
means for monitoring a plurality of physical connections of the submarine cable network;
means for selectively receiving alarm signals from the monitoring means; and
means for reconfiguring the submarine cable network based upon the received alarm signals.

28. The system according to claim 27, wherein the reconfiguring means restores service of the submarine cable network according to a plurality of classes of services.

29. The system according to claim 27, wherein the reconfiguring means provides provisioning of services on the submarine cable network.
